(19) United States
(12) Patent Application Publication
(10) Pub. No.: US 2024/0311378 A1
(43) Pub. Date: Sep. 19, 2024

(54) System for Near Object Detection Using Quadtree and Method Thereof

(71) Applicant: Arka Energy Inc., Union City, CA (US)

(72) Inventor: Nikhil Shaji, Kottayam Kerala (IN)

(21) Appl. No.: 18/606,582

(22) Filed: Mar. 15, 2024

(30) Foreign Application Priority Data
Mar. 16, 2023 (IN) 202311017892

(51) Int. Cl. G06F 16/2455; G06F 16/22

(52) U.S. Cl. CPC G06F 16/24568; G06F 16/2246

(57) ABSTRACT

Embodiments of present disclosure relate to a system (100) and a method (400) that involves initializing a root quadtree by a processor (104) to efficiently store and search for spatial data based on the boundaries of objects. The objects are assigned to quadrants based on their boundaries using an overlap check technique, and quadrants are recursively divided until they contain no more objects than a given threshold. Additionally, a querying process is used to search for objects based on their coordinates, and all objects within the queried quadrant are considered neighbors. This process provides an efficient means of storing and searching for spatial data and is widely used in computer science and related fields.

### CROSS-REFERENCE TO RELATED APPLICATION

This application claims priority to and the benefit of Indian Patent Application No. 202311017892 filed on Mar. 16, 2023, which is hereby incorporated by reference herein in its entirety.

### TECHNICAL FIELD

The present disclosure, in general, relates to a quadtree. More particularly, it relates to a system and a method for object detection using a quadtree.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

Near object detection is a crucial task in various fields, including robotics, computer vision, and autonomous systems. The traditional techniques for near-object detection rely on the spatial indexing of objects based on their coordinates. However, these techniques face significant challenges when the number of objects in a space is large or when the object's size and shape are not uniform.

Existing traditional technique for near object detection is spatial partitioning method. This method divides the space into smaller regions, such as grids or cells, and places objects in their corresponding cells based on their coordinates. However, this technique faces several limitations, including the difficulty of efficiently handling objects that span multiple cells, the problem of non-uniform cell sizes, and the need for frequent updates to maintain the data structure's integrity.

Another existing technique is k-d tree data structure, which recursively partitions space into smaller regions based on the objects' coordinates. However, this method has a high computational cost, especially when the number of objects is large, and it is challenging to balance the tree.

There are also other techniques such as R-trees and quadtrees. R-trees are tree-based data structures that partition space into rectangles, and objects are placed in the corresponding rectangles based on their coordinates. However, R-trees face challenges in handling dynamic data, and the cost of querying increases as the number of objects in the tree increases. Quadtrees divide the space recursively into smaller square quadrants and place objects in the corresponding quadrants based on their coordinates. However, the traditional quadtree approach has limitations in handling non-uniformly sized objects and objects that span multiple quadrants.

There is, therefore, a need to overcome the above drawback, limitations, and shortcomings associated with the existing techniques by providing a solution that is efficient and scalable and handles non-uniformly sized objects and objects that span multiple quadrants while maintaining a low computational cost.

### OBJECTS OF THE PRESENT DISCLOSURE

Some of the objects of the present disclosure, which at least one embodiment herein satisfy are as listed herein below.

A general object of the present disclosure is to provide a system that places objects based on their boundaries, ensuring that objects of varying sizes are accommodated efficiently. This capability enables the system to handle non-uniformly sized objects more efficiently than traditional techniques.

Another object of the present disclosure is to utilize overlap check technique that enables placement of objects that span multiple quadrants, which is a significant limitation of traditional quadtree approaches.

Another object of the present disclosure is to provide a system that uses a dynamic threshold to determine the maximum number of objects in a quadrant, and if the threshold is exceeded, the quadrant is divided into smaller sub-quadrants. This approach ensures that the system handles a large number of objects efficiently while maintaining a low computational cost.

Another object of the present disclosure is to provide a system that utilises dynamic threshold and sub-quadrant division that ensures efficient use of memory resources. The system only stores objects in the quadrants where they belong, and sub-quadrants are created only when the threshold is exceeded, which results in efficient use of memory.

Another object of the present disclosure is to provide a system that utilize querying process efficiently searches for nearby objects by traversing the quadtree structure and considering all the child objects of the queried quadrant as neighbours of the querying coordinate, ensuring a comprehensive search for nearby objects.

### SUMMARY

Various aspects of present disclosure relates to a quadtree. More particularly, it relates to a system and a method for object detection using a quadtree. Overall, the proposed invention provides an efficient and scalable system for near-object detection that handles non-uniformly sized objects and objects that span multiple quadrants while maintaining a low computational cost. Additionally, the proposed system and method utilises dynamic threshold and sub-quadrant division that ensures efficient use of memory resources. The system only stores objects in the quadrants where they belong, and sub-quadrants are created only when the threshold is exceeded, which results in efficient use of memory.

An aspect of present disclosure pertains to a system for near object detection using quadtree, the system may include a processor configured to initialize a root quadtree to place objects based on their boundaries, where the object is considered a child of the quadrant if the boundary of the object overlaps with an axis of the quadrant or is inside the quadrant, and an overlap check technique checks the boundary lies inside to determine at least one of the conditions for placing the object in the quadrant. Additionally, the processor may be configured to determine the maximum number of objects, the quadrant accommodates and compare with a threshold, and when the threshold is exceeded, the quadrant may be divided into sub quadrant, and process may be repeated until the number of objects within each quadrant remains below the threshold. Further, the process may be configured to initiate a querying process that checks query coordinate with the root quadrant and returns the quadrant where the coordinate lies and the process continues until all child quadrants are queried, and all the children objects of the queried quadrant are considered as neighbours of the querying coordinate.

According to another aspect of present disclosure, a method for near object detection using quadtree is disclosed. The method includes initializing by a processor, a root quadtree to place objects based on their boundaries, where the object may be considered a child of the quadrant if the boundary of the object overlaps with an axis of the quadrant or is inside the quadrant, using an overlap check technique checking the boundary lies inside to determine at least one condition for placing the object in the quadrant. The method may also include determining the maximum number of objects the quadrant hold and comparing it with a threshold, wherein if the threshold is exceeded, the quadrant may be divided into sub-quadrants and the process may be repeated until the number of objects within each quadrant remains below the threshold. Further, the method includes initiating a querying process that checks the query coordinate with the root quadrant and returns the quadrant where the coordinate lies and the process continues until all child quadrants may be queried, and all the children objects of the queried quadrant may be considered as neighbours of the querying coordinate.

Various objects, features, aspects, and advantages of the present disclosure will become more apparent from the following detailed description of preferred embodiments, along with the accompanying drawing figures in which like numerals represent like features.

### BRIEF DESCRIPTION OF THE ACCOMPANYING DRAWINGS

The accompanying drawings are included to provide a further understanding of the present disclosure, are incorporated in, and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates a block diagram of a system to detect objects using a quadtree, in accordance with an embodiment of the present disclosure.

FIG. 2 illustrates exemplary functional components of a processing engine of the system, in accordance with an embodiment of the present disclosure.

FIG. 3 illustrates a method for detecting objects using a quadtree, in accordance with an embodiment of the present disclosure.

FIG. 4 illustrates a flow chart of a process for detecting objects using a quadtree, in accordance with an embodiment of the present disclosure.

FIG. 5 illustrates a flow chart of a process for checking boundary box, in accordance with an embodiment of the present disclosure.

FIG. 6 illustrates an exemplary computer system to implement proposed system, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims. Embodiments of present disclosure relate to a quadtree. More particularly, it relates to a system and a method for object detection using a quadtree. The proposed system and method utilises dynamic threshold and sub-quadrant division that ensures efficient use of memory resources. The system only stores objects in the quadrants where they belong, and sub-quadrants are created only when the threshold is exceeded, which results in efficient use of memory.

An embodiment of present disclosure pertains to a system for near object detection using quadtree, the system may include a processor configured to initialize a root quadtree to place objects based on their boundaries, where the object is considered a child of the quadrant if the boundary of the object overlaps with an axis of the quadrant or is inside the quadrant, and an overlap check technique checks the boundary lies inside to determine at least one of the conditions for placing the object in the quadrant. Additionally, the processor may be configured to determine the maximum number of objects, the quadrant accommodates and compare with a threshold, and when the threshold is exceeded, the quadrant may be divided into sub quadrant, and process may be repeated until the number of objects within each quadrant remains below the threshold. Further, the process may be configured to initiate a querying process that checks query coordinate with the root quadrant and returns the quadrant where the coordinate lies and the process continues until all child quadrants are queried, and all the children objects of the queried quadrant are considered as neighbours of the querying coordinate.

According to another embodiment of present disclosure, a method for near object detection using quadtree is disclosed. The method includes initializing by a processor, a root quadtree to place objects based on their boundaries, where the object may be considered a child of the quadrant if the boundary of the object overlaps with an axis of the quadrant or is inside the quadrant, using an overlap check technique checks the boundary lies inside to determine at least one condition for placing the object in the quadrant. The method may also include determining the maximum number of objects the quadrant hold and comparing it with a threshold, wherein if the threshold is exceeded, the quadrant may be divided into sub-quadrants and the process may be repeated until the number of objects within each quadrant remains below the threshold. Further, the method includes initiating a querying process that checks the query coordinate with the root quadrant and returns the quadrant where the coordinate lies and the process continues until all child quadrants may be queried, and all the children objects of the queried quadrant may be considered as neighbours of the querying coordinate.

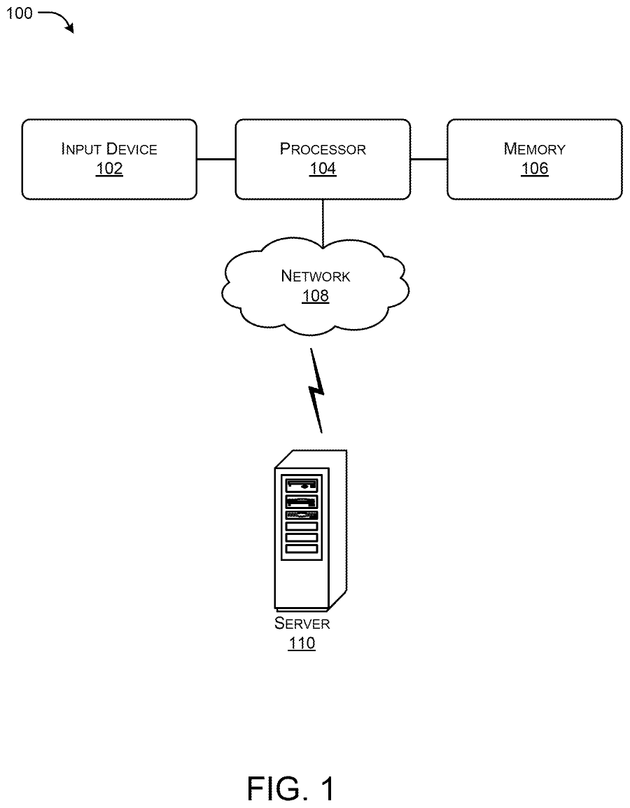

FIG. 1 illustrates a block diagram of a system to detect objects using a quadtree, in accordance with an embodiment of the present disclosure.

As illustrated, a system 100 to detect objects using a quadtree is disclosed. The system 100 includes an input device 102 such as, but not limited to, a desktop computer, a laptop, a PDA, a mobile device, a smartphone, a tablet computer, keyboard, mouse and the like. The system 100 includes a processor 104 that can be communicatively coupled to the input device 102, and a memory 106. The processor 104 includes suitable logic, circuitry, and/or interfaces that are operable to execute one or more instructions stored in the memory 106 to perform pre-determined operation of the system. The memory 106 may be operable to store the one or more instructions. The processor 104 may be implemented using one or more processor technologies known in the art. Examples of the processor 104 include but are not limited to, an x86 processor, a RISC processor, an ASIC processor, a CISC processor, an Arduino Uno board, an ESP 8266 node microcontroller, or any other processor.

The memory 106 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the memory 106 includes the one or more instructions that are executable by the processor 104 to perform specific operations. It will be apparent to a person having ordinary skill in the art that the one or more instructions stored in the memory 106 enable multiple components of the system 100 to perform predetermined operations.

In an embodiment, the processor 104 may be configured to detect near object, firstly, objects received from the input unit 102 are divided among quadrants of a quadtree based on the coverage of their boundaries. The quadtree is a data structure commonly used in computer science to efficiently store and search for spatial data, based on the boundaries of objects. This is typically done by the processor, which creates the quadtree and populates it with objects. In an exemplary embodiment, the quadtree is a hierarchical structure, with a root node representing the entire space being considered. The root node is then recursively divided into four quadrants, each representing a smaller section of the space. Each object in the space is assigned to a quadrant based on its boundary, using an overlap check technique that determines if the object lies entirely within a quadrant or if its boundary overlaps with an axis of the quadrant. If the object meets at least one of these conditions, it is considered a child of the quadrant and is placed within it.

Further, once the objects have been assigned to their respective quadrants, the maximum number of objects that a quadrant can hold is determined and compared to a threshold. If the number of objects in a quadrant exceeds the threshold, the quadrant is divided into four sub-quadrants and the process is repeated recursively until each quadrant contains no more than the maximum number of objects allowed by the threshold.

Finally, a querying process is initiated to search the quadtree for objects based on their coordinates. This process begins by checking the query coordinate against the root quadrant, and then recursively traverses through the child quadrants until the query coordinate is located. When a quadrant containing the query coordinate is found, all of its child objects are considered neighbours of the query coordinate.

In an embodiment, type of objects, and threshold can be stored on a server 110 or can be received through the input unit. The server 110 can be communicatively coupled to the processor through a network 108. The network 108 corresponds to a medium through which content and messages flow between various devices of the system 100. Examples of the network may include, but are not limited to, a Wireless Fidelity (Wi-Fi) network, a Wide Area Network (WAN), a Local Area Network (LAN), or a Metropolitan Area Network (MAN). Various devices in the system 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

In an embodiment, the server may receive a query from the input device 102. For querying the server, one or more querying languages may be utilized such as, but not limited to, SQL, QUEL, DMX and so forth. Further, the server may be realized through various technologies such as, but not limited to, Microsoft® SQL server, Oracle, and My SQL. In an embodiment, the server may connect to the input device 102 using one or more protocols such as, but not limited to, ODBC protocol and JDBC protocol.

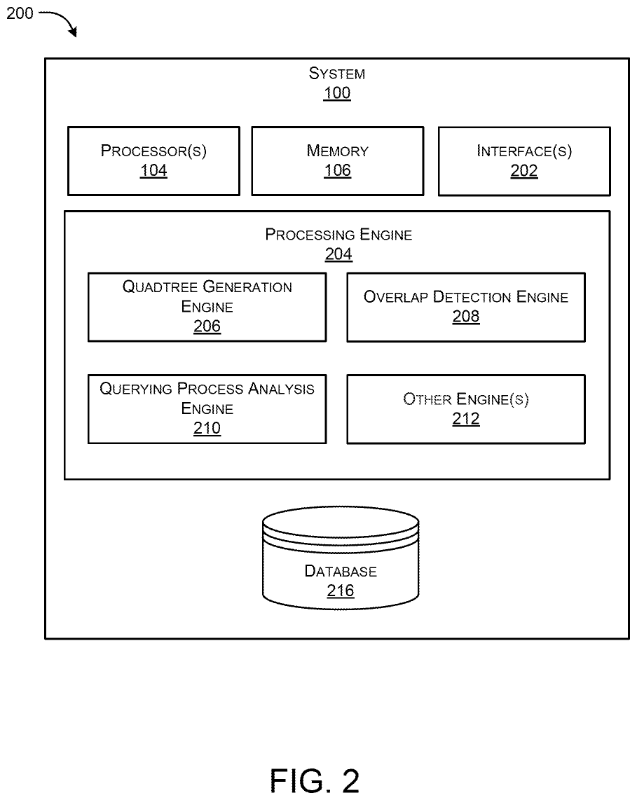

FIG. 2 illustrates exemplary functional components of a processing engine of the system, in accordance with an embodiment of the present disclosure.

In an embodiment, a system 100 includes a processor 104, a memory 106, and one or more interface(s) 202. The interface 202 may include a variety of interfaces, for example, interfaces for data input and output devices, referred to as I/O devices, storage devices, and the like. The interface 202 may also provide a communication pathway for one or more components of system 100. Examples of such components include, but are not limited to, a processing engine 204 and a database 216.

The processing engine 204 is provided with the processor 104, and it can be implemented as a combination of hardware and programming (for example, programmable instructions) to implement one or more functionalities of the processing engine 204. In examples described herein, such combinations of hardware and programming may be implemented in several different ways. For example, the programming for the processing engine 204 may be processing unit executable instructions stored on a non-transitory machine-readable storage medium, and the hardware for the processing engine 204 may include a processing resource (for example, one or more processors), to execute such instructions. In the present examples, the machine-readable storage medium may store instructions that, when executed by the processing resource, implement the processing engine 204. In such examples, the processing engine 204 can include the machine-readable storage medium storing the instructions and the processing resource to execute the instructions, or the machine-readable storage medium may be separate but accessible to the processor 104 and the processing resource. In other examples, the processing engine 204 can be implemented by electronic circuitry.

In an embodiment, the processing engine 204 includes a quadtree generation engine 206, an overlap detection engine 208, a querying process analysis engine 210, and other engine(s) 212. The other engine(s) 212 can implement functionalities that supplement applications or functions performed by system 100 or the processing engine 204. It would be appreciated that the modules being described are only exemplary modules and any other modules or sub-modules may be included as part of system 100. These units too may be merged or divided into super-modules or sub-modules as may be configured. In addition, database 216 includes data that is either stored or generated as a result of functionalities implemented by any of the components of system 100.

In an embodiment, the quadtree generation engine 206 may be configured to initialize, a root quadtree to place objects based on their boundaries. The object may be considered a child of the quadrant if the boundary of the object overlaps with an axis of the quadrant or is inside the quadrant.

In an embodiment, the overlap detection engine 208 may be configured to check boundary lies inside the quadrant using overlap check technique to determine at least one of the conditions for placing the object in the quadrant. Additionally, the overlap detection engine 208 may be configured to determine the maximum number of objects, the quadrant accommodates and compare with a threshold. When the threshold is exceeded, the quadrant may be divided into sub quadrant, and process is repeated until the number of objects within each quadrant remains below the threshold.

In an embodiment, querying process analysis engine 210 may be configured to initiate a querying process that checks query coordinate with the root quadrant and returns the quadrant where the coordinate lies, and the process continues until all child quadrants are queried, When all the children objects of the queried, the quadrant may be considered as neighbours of the querying coordinate.

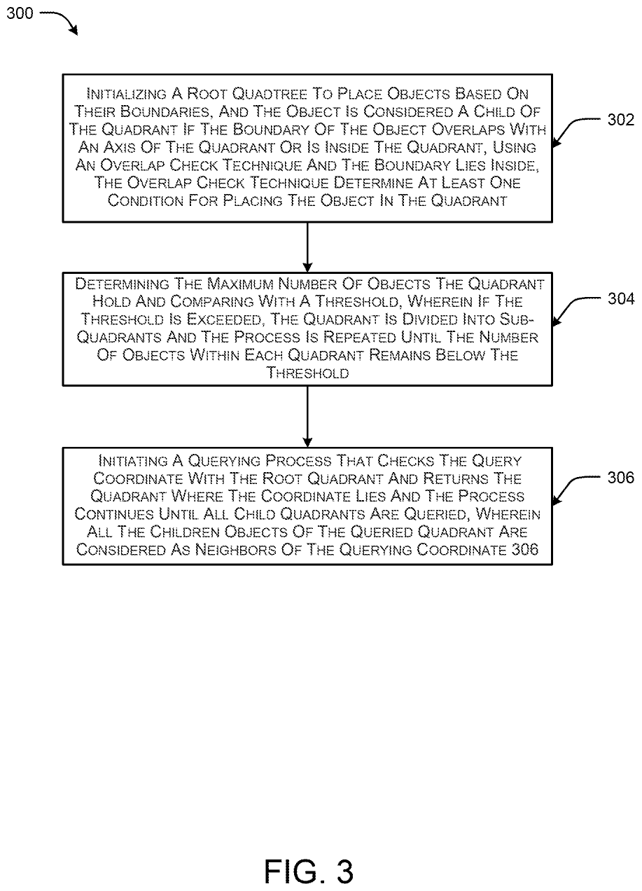

FIG. 3 illustrates a method for detecting objects using a quadtree, in accordance with an embodiment of the present disclosure. As illustrated, at block 302, a method 300 includes initializing, by a processor 104, a root quadtree to place objects based on their boundaries, and the object may be considered a child of the quadrant if the boundary of the object overlaps with an axis of the quadrant or is inside the quadrant, using an overlap check technique checks the boundary lies inside, to determine at least one condition for placing the object in the quadrant.

As illustrated, at block 304, a method 300 includes, by the processor 104 determining the maximum number of objects the quadrant hold and comparing with a threshold. The threshold may be adjustable based on an input received from an entity. When the threshold is exceeded, the quadrant may be divided into sub-quadrants and the process is repeated until the number of objects within each quadrant remains below the threshold.

As illustrated, at block 306, a method 300 includes initiating a querying process that checks the query coordinate with the root quadrant and returns the quadrant where the coordinate lies and the process continues until all child quadrants are queried. The querying process includes searching for objects within a predefined distance of the querying coordinate. Additionally, all the children objects of the queried quadrant may be considered as neighbours of the querying coordinate. Further, the processor 104 may be configured for providing a rank to neighboring objects based on their distance from the querying coordinate.

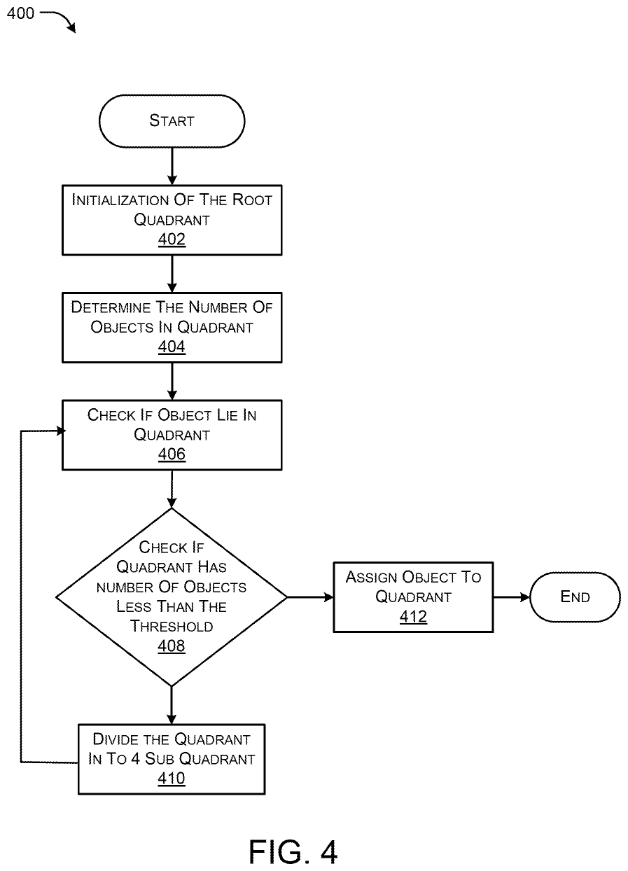

FIG. 4 illustrates a flow chart 400 of a process for detecting objects using a quadtree, in accordance with an embodiment of the present disclosure.

As illustrated, at block 402, initialization of a root quadtree is done, and at block 404, number of objects in the initialized quadrant is determined. Continuing further, at block 406, it is checked, whether object lies in the quadrant, by checking, if quadrant has number of objects less than a threshold, as shown at block 408. The threshold can be set by a user by an input unit. Continuing further, when determination is no at block 408, divide the quadrant in four sub-quadrant, as shown at block 410, and repeat the block 406. However, when determination is yes, at block 408, assign objects to the quadrant, as shown at block 412, and the process ends.

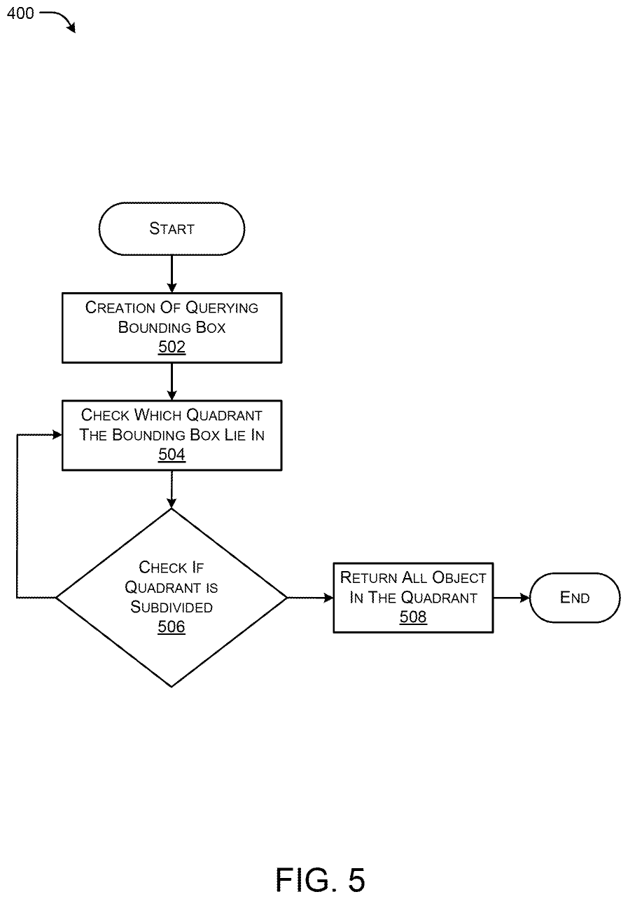

FIG. 5 illustrates a flow chart 500 of a process for checking boundary box, in accordance with an embodiment of the present disclosure.

As illustrated, at block 502, a querying boundary box is created, and it is checked in which quadrant the boundary box lies in, at block 504. Continuing further, it is checked, at block 506, if the quadrant is subdivided or not, when determination is no, return all objects in the quadrant, and the process ends. However, when determination is yes at 506, repeat block 504.

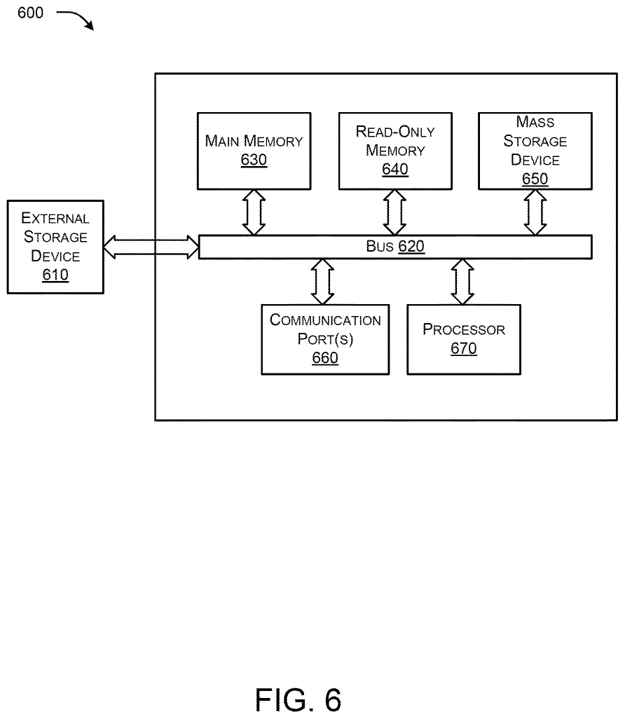

FIG. 6 illustrates an exemplary computer system to implement proposed system, in accordance with an embodiment of the present disclosure.

As shown in FIG. 6, a computer system 600 can include an external storage device 610, a bus 620, a main memory 630, a read only memory 640, a mass storage device 650, communication port 660, and a processor 670. A person skilled in the art will appreciate that the computer system may include more than one processor and communication ports. Examples of processor 670 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 670 may include various modules associated with embodiments of the present invention. Communication port 660 can be any of an RS-232 port for use with a modem-based dialup connection, a 10/100 Ethernet port, a Gigabit or 10 Gigabit port using copper or fibre, a serial port, a parallel port, or other existing or future ports. Communication port 660 may be chosen depending on a network, such a Local Area Network (LAN), Wide Area Network (WAN), or any network to which computer system connects. Memory 630 can be Random Access Memory (RAM), or any other dynamic storage device commonly known in the art. Read-only memory 640 can be any static storage device(s) e.g., but not limited to, a Programmable Read Only Memory (PROM) chips for storing static information e.g., start-up or BIOS instructions for processor 670. Mass storage 650 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 620 communicatively couples processor(s) 670 with the other memory, storage, and communication blocks. Bus 620 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 670 to software system.

Optionally, operator and administrative interfaces, e.g., a display, keyboard, and a cursor control device, may also be coupled to bus 620 to support direct operator interaction with a computer system. Other operator and administrative interfaces can be provided through network connections connected through communication port 660. The external storage device 610 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Embodiments disclosed herein provide system and method that uses dynamic threshold to determine the maximum number of objects in a quadrant, and if the threshold is exceeded, the quadrant is divided into smaller sub-quadrants. This approach ensures that the system handles a large number of objects efficiently while maintaining a low computational cost. Further, the system only stores objects in the quadrants where they belong, and sub-quadrants are created only when the threshold is exceeded, which results in efficient use of memory.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced.

Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to those having ordinary skill in the art.

### Advantages of the Invention

The present disclosure provides a system and method that applies RANSAC and planar segmentation algorithms to accurately detect location and extent of obstructions on a roof, such as chimneys, skylights, and other objects. This helps to identify areas where solar panels cannot be installed, allowing for precise planning and optimization of the solar installation.

The present disclosure provides a system that places objects based on their boundaries, ensuring that objects of varying sizes are accommodated efficiently. This capability enables the system to handle non-uniformly sized objects more efficiently than traditional techniques.

The present disclosure utilize overlap check technique that enables placement of objects that span multiple quadrants, which is a significant limitation of traditional quadtree approaches.

The present disclosure provides a system that uses a dynamic threshold to determine the maximum number of objects in a quadrant, and if the threshold is exceeded, the quadrant is divided into smaller sub-quadrants. This approach ensures that the system handles a large number of objects efficiently while maintaining a low computational cost.

The present disclosure provides a system that utilises dynamic threshold and sub-quadrant division that ensures efficient use of memory resources. The system only stores objects in the quadrants where they belong, and sub-quadrants are created only when the threshold is exceeded, which results in efficient use of memory.

The present disclosure provides a system that utilize querying process efficiently searches for nearby objects by traversing the quadtree structure and considering all the child objects of the queried quadrant as neighbours of the querying coordinate, ensuring a comprehensive search for nearby objects.

We claim:

1. A system for near object detection using quadtree, the system comprising:
a processor; and
a memory storing instructions that, when executed by the processor, cause the processor to perform:
initialize, a root quadtree to place objects based on their boundaries, wherein the object is considered a child of the quadrant if the boundary of the object overlaps with an axis of the quadrant or is inside the quadrant, wherein an overlap check technique checks the boundary lies inside to determine at least one of the conditions for placing the object in the quadrant;
determine, the maximum number of objects, the quadrant accommodates and compare with a threshold, wherein when the threshold is exceeded, the quadrant is divided into sub quadrant, and process is repeated until the number of objects within each quadrant remains below the threshold; and
initiate, a querying process that checks query coordinate with the root quadrant and returns the quadrant where the coordinate lies, and the process continues until all child quadrants are queried, wherein all the children objects of the queried, the quadrant are considered as neighbours of the querying coordinate.

2. The system as claimed in claim 1, wherein the threshold is adjustable based on an input received from an entity.

3. The system as claimed in claim 1, wherein the querying process comprises searching for the objects within a predefined distance of the querying coordinate.

4. The system as claimed in claim 1, wherein the processor is configured to provide rank to the neighboring objects based on their distance from the querying coordinate.

5. A method for near object detection using quadtree, comprising:
initializing, by a processor, a root quadtree to place objects based on their boundaries, wherein the object is considered a child of the quadrant if the boundary of the object overlaps with an axis of the quadrant or is inside the quadrant, using an overlap check technique checking the boundary lies inside to determine at least one condition for placing the object in the quadrant;
determining the maximum number of objects the quadrant hold and comparing with a threshold, wherein if the threshold is exceeded, the quadrant is divided into sub-quadrants and the process is repeated until the number of objects within each quadrant remains below the threshold; and
initiating a querying process that checks the query coordinate with the root quadrant and returns the quadrant where the coordinate lies and the process continues until all child quadrants are queried, wherein all the children objects of the queried quadrant are considered as neighbours of the querying coordinate.

6. The method as claimed in claim 5, wherein the threshold is adjustable based on an input received from an entity.

7. The method as claimed in claim 5, wherein the querying process comprises searching for objects within a predefined distance of the querying coordinate.

8. The method as claimed in claim 5, wherein the processor is configured for providing a rank to neighboring objects based on their distance from the querying coordinate.
